(19) United States
(12) Patent Application Publication
(10) Pub. No.: US 2026/0270353 A1
(43) Pub. Date: Sep. 10, 2026

(54) MEDIUM CONVEYANCE APPARATUS AND IMAGE READING APPARATUS

(71) Applicant: SEIKO EPSON CORPORATION, Tokyo (JP)

(72) Inventors: Sekito MASARU, KITAKYUSHU-SHI (JP); Hiroki NAKASHIMA, FUKUOKA-SHI (JP); Kazuhiko ARIMORI, KITAKYUSHU-SHI (JP)

(21) Appl. No.: 19/553,520

(22) Filed: Mar. 2, 2026

(30) Foreign Application Priority Data
Mar. 4, 2025 (JP) 2025-033607

(51) Int. Cl. H04N 1/00

(52) U.S. Cl. CPC H04N 1/00628; H04N 1/00588; H04N 1/00602; H04N 1/00649

(57) ABSTRACT

A medium conveyance apparatus includes a feed roller configured to apply feeding force in a conveyance direction to a medium placed on a medium placement section by rotating in contact with the medium, a separation roller configured to rotate in an opposite direction to a direction of the rotation of the feed roller to apply separation force to the media except a first medium that receives the feeding force out of a bundle of media, and a controller configured to control operations of the feed roller and the separation roller. The controller performs control such that a peripheral speed of the separation roller is equal to or higher than a peripheral speed of the feed roller during a predetermined period after the feed roller applies the feeding force to the first medium.

The present application is based on, and claims priority from JP Application Serial Number 2025-033607, filed Mar. 4, 2025, the disclosure of which is hereby incorporated by reference herein in its entirety.

### BACKGROUND

### Technical Field

The present disclosure relates to a medium conveyance apparatus and an image reading apparatus.

### Related Art

Examples of the related art of an apparatus of this kind include an apparatus described in JP-A-2019-68125.

JP-A-2019-68125 discloses an image reading apparatus including a roller pair of a feed roller and a separation roller that rotates in an opposite direction to a rotational direction of the feed roller. When the separation roller rotates in the opposite direction, the roller pair separates one medium from a bundle of a plurality of media placed on the medium placement section and sends the medium downstream in the conveyance direction, that is, feeds the medium.

In the related art, the peripheral speed of the separation roller is set to be lower than the peripheral speed of the feed roller.

In addition, in the related art, the feed roller stops the rotation when a trailing end of a first medium thus separated leaves the feed roller, and then resumes the rotation when separating a subsequent second medium. Meanwhile, when performing the separation of the second medium following the separation of the first medium, the separation roller continues to rotate at a constant speed without stopping the rotation.

JP-A-2019-68125 is an example of the related art.

However, for example, when a plurality of media is set on the medium placement section in an unaligned state where the leading ends of the media are not aligned with each other, the media cannot be separated one by one with the related-art structure in some cases. That is, in the related-art structure, double-feeding with a plurality of media is likely to occur.

### SUMMARY

In order to solve the problem described above, a medium conveyance apparatus according to the present disclosure includes: a medium placement section on which a bundle of media is placed; a feed roller configured to apply feeding force in a conveyance direction to the media placed on the medium placement section by rotating in contact with the media; a separation roller configured to rotate in an opposite direction to a direction of the rotation of the feed roller to apply separation force to the media except a first medium which receives the feeding force out of the bundle of the media; and a controller configured to control operations of the feed roller and the separation roller, wherein the controller performs control such that a peripheral speed of the separation roller is equal to or higher than a peripheral speed of the feed roller during a predetermined period after the feed roller applies the feeding force to the first medium.

An image reading apparatus according to the present disclosure includes a medium conveyance apparatus according to any one of first to seventh aspects described later, and a reading unit that reads an image on the medium conveyed in the conveyance direction by the medium conveyance apparatus.

### BRIEF DESCRIPTION OF THE DRAWINGS

FIG. 1 is a schematic side view of an image reading apparatus according to Embodiment 1.

FIG. 2 is a graph illustrating changes in peripheral speeds of a feed roller and a separation roller when separating a first medium in a medium conveyance apparatus according to Embodiment 1.

FIG. 3 is a graph illustrating changes in peripheral speeds of the feed roller and the separation roller when separating a second medium in the medium conveyance apparatus according to Embodiment 1.

FIG. 4 is a schematic side view of an essential part illustrating the separation of the first medium in Embodiment 1.

FIG. 5 is a schematic side view of an essential part illustrating the separation of the first medium in Embodiment 1.

FIG. 6 is a schematic side view of an essential part illustrating the separation of the first medium in Embodiment 1.

FIG. 7 is a schematic side view of an essential part illustrating the separation of the first medium in Embodiment 1.

FIG. 8 is a schematic side view of an essential part illustrating the separation of the first medium in Embodiment 1.

FIG. 9 is a schematic side view of an essential part illustrating the separation of the first medium in Embodiment 1.

### DESCRIPTION OF EMBODIMENTS

First, the present disclosure will schematically be described below.

In order to solve the problem described above, a medium conveyance apparatus according to the first aspect of the present disclosure includes: a medium placement section on which a bundle of media is placed; a feed roller configured to apply feeding force in a conveyance direction to the media placed on the medium placement section by rotating in contact with the media; a separation roller configured to rotate in an opposite direction to a direction of the rotation of the feed roller to apply separation force to the media except a first medium which receives the feeding force out of the bundle of the media; and a controller configured to control operations of the feed roller and the separation roller, wherein the controller performs control such that a peripheral speed of the separation roller is equal to or higher than a peripheral speed of the feed roller during a predetermined period after the feed roller applies the feeding force to the first medium.

Here, the "predetermined period" in the "predetermined period after the feeding force is applied to the first medium by the feed roller" is determined such that the double-feeding of the media can be reduced by controlling the peripheral speed of the separation roller to be equal to or higher than the peripheral speed of the feed roller.

According to the present aspect, the controller is configured to perform the control so that the peripheral speed of the separation roller is equal to or higher than the peripheral speed of the feed roller during the predetermined period after applying the feeding force by the feed roller to the first medium. As a result, since a retreating speed in the opposite direction of the media other than the first medium by the separation roller becomes faster than ever before, the separation function with the separation roller is enhanced. That is, for example, even when the plurality of media are set on the medium placement section in an unaligned state in which the leading ends thereof are not aligned, the separation function is less likely to be affected by the unaligned state of the plurality of media. As a result, the first medium can be easily separated, and thus it is possible to reduce the possibility of causing double-feeding.

In addition, by the rotation of the separation roller in the opposite direction in the predetermined period, the state is changed toward the state in which the leading ends of the media set in the unaligned state are aligned. Accordingly, it is possible to remedy the unaligned state of the downstream leading ends of the plurality of media. Therefore, in the separation processing of the second and subsequent media following the first medium, the processing can be performed in a state where the leading ends of the media are aligned.

A medium conveyance apparatus according to the second aspect of the present disclosure is an aspect according to the first aspect, wherein the controller can receive a change command to change a length of the predetermined period, and change the length of the predetermined period upon reception of the change command.

The degree of appropriateness of the predetermined period may change in some cases due to a difference in type of the medium to be separated, a change in environment such as temperature and humidity, and so on.

According to the present aspect, the controller is configured to change the predetermined period to a new length of the predetermined period based on the change command for changing the length of the predetermined period upon reception of the change command. Accordingly, the length of the predetermined period can be changed in accordance with the difference in type of the medium, the change in environment such as temperature and humidity, and so on. Accordingly, it is possible to realize effective separation of the bundle of the unaligned media.

A medium conveyance apparatus according to the third aspect of the present disclosure is an aspect according to the first aspect, wherein the controller performs control such that the peripheral speed of the feed roller is higher than the peripheral speed of the separation roller after the predetermined period elapses.

Note that the present aspect can also be dependent from the second aspect.

According to this aspect, the controller is configured to perform the control such that the peripheral speed of the feed roller becomes higher than the peripheral speed of the separation roller after the predetermined period elapses. Thus, it is possible to improve throughput in the conveyance of the medium accordingly by an increase in the peripheral speed of the feed roller.

A medium conveyance apparatus according to the fourth aspect of the present disclosure is an aspect according to the first aspect, further including a conveyance roller configured to convey the medium downstream in the conveyance direction of the feed roller, wherein the predetermined period ends when a leading end of the first medium separated is nipped by the conveyance roller.

Note that the present aspect can also be dependent from the second aspect or the third aspect.

According to this aspect, the predetermined period ends when the leading end of the first medium thus separated is nipped by the conveyance roller, that is, when the leading end is nipped and provided with the conveyance force. Accordingly, it is possible to more effectively suppress the possibility of double-feeding due to the bundle of unaligned media. Further, at the same time, it is possible to further remedy the unaligned state of the downstream leading ends of the plurality of media set on the medium placement section in the unaligned state.

A medium conveyance apparatus according to the fifth aspect of the present disclosure is an aspect according to the first aspect, wherein the controller performs control such that the peripheral speed of the feed roller is higher than the peripheral speed of the separation roller when separating a second medium following the first medium.

Note that the present aspect can also be dependent from any one of the second to fourth aspects.

According to this aspect, the controller is configured to perform the control such that the peripheral speed of the feed roller is higher than the peripheral speed of the separation roller when separating the second medium following the first medium.

As described above, in the separation processing of the first medium, the unaligned state of the downstream leading ends of the bundle of the plurality of media is remedied. Therefore, in the separation processing of the second medium, the processing of remedying the unaligned state as in the first medium is unnecessary. Accordingly, it is possible to control the peripheral speed of the feed roller to be higher than the peripheral speed of the separation roller. Therefore, when separating the second medium, it is possible to improve the throughput in the conveyance of the second and subsequent media accordingly by the fact that the peripheral speed of the feed roller is set high from the beginning.

A medium conveyance apparatus according to the sixth aspect of the present disclosure is an aspect according to the first aspect, wherein the controller controls the peripheral speed of the separation roller so as to be substantially the same between when separating the first medium and when separating the second medium.

Note that the present aspect can also be dependent from any one of the second to fifth aspects.

According to this aspect, the controller is configured to control the peripheral speed of the separation roller so as to be substantially the same between when separating the first medium and when separating the second medium. That is, the peripheral speed of the feed roller only changes between when separating the first medium and when separating the second medium, but the peripheral speed of the separation roller does not change between when separating the first medium and when separating the second medium. Therefore, it is possible to suppress complication of the control by the controller.

A medium conveyance apparatus according to the seventh aspect of the present disclosure is an aspect according to the first aspect, wherein the controller performs control such that the peripheral speed of the separation roller is equal to or greater than the peripheral speed of the feed roller during a predetermined period after the feeding force is applied by the feed roller to an (N+2)-th medium following separation of a predetermined number N (N is a positive integer no smaller than 3) of media from the separation of the first medium.

Here, the "predetermined number N" is the number of media set in advance based on the size, the peripheral speed, and so on of the separation roller.

Note that the present aspect can also be dependent from any one of the second to sixth aspects.

When the number of media in the bundle set on the medium placement section is large, the range in which the leading ends of the media are unaligned also increases. Therefore, the unaligned state is remedied by the separation processing of the first medium only in the media that are located at the position where the media are brought into contact with the separation roller, and the unaligned state is apt to be maintained in the media located apart from the separation roller.

However, according to the present aspect, the controller performs the control so that the peripheral speed of the separation roller is equal to or higher than the peripheral speed of the feed roller similarly to the separation processing of the first medium during the predetermined period after applying the feeding force by the feed roller to the (N+2)-th medium following the execution of the separation processing of the predetermined number N of media. Accordingly, substantially the same advantages as in the first aspect can be obtained for the (N+2)-th and subsequent media in the bundle.

An image reading apparatus according to the eighth aspect of the present disclosure includes the medium conveyance apparatus according to any one of the first to seventh aspects, and a reading unit that reads an image on the medium conveyed in the conveyance direction by the medium conveyance apparatus.

According to the present aspect, it is possible to obtain substantially the same advantages as those of any one of the first to seventh aspects as the image reading apparatus.

### Embodiments

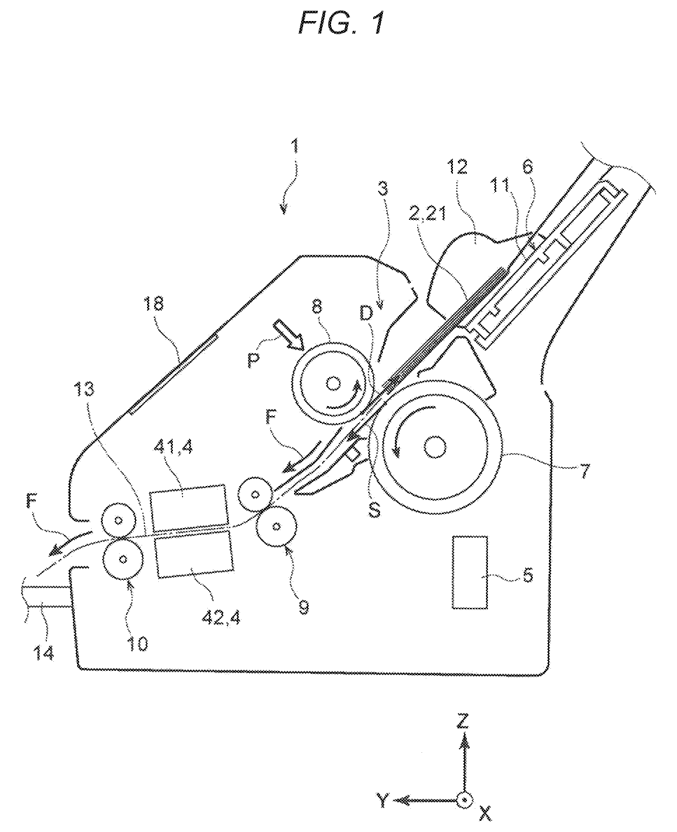

Hereinafter, medium conveyance apparatuses according to some embodiments of the present disclosure and an image reading apparatus including one of the medium conveyance apparatuses will specifically be described with reference to FIGS. 1 to 9.

In the following description, three axes orthogonal to each other are respectively defined as an X axis, a Y axis, and a Z axis as illustrated in the drawings. Directions indicated by arrows of the three axes (X, Y, and Z) are positive (+) directions of the respective directions, and opposite directions thereof are negative (-) directions. The Z-axis direction corresponds to a vertical direction, that is, a direction in which the gravitational force acts, the +Z direction represents a vertically upward direction and the -Z direction represents a vertically downward direction. The X-axis direction and the Y-axis direction are equivalent to a horizontal direction. The +X direction represents the right side of the image reading apparatus, and the -X direction represents the left side of the image reading apparatus. The +Y direction represents the front side of the image reading apparatus, and the -Y direction represents the rear side of the image reading apparatus.

### General Description of Whole of Image Reading Apparatus

As illustrated in FIG. 1, the image reading apparatus 1 in the present embodiments is a document scanner capable of reading an image on a medium 2. Here, the image refers to what is visually recorded on the medium 2 such as a character, a diagram, a table, a painting, or a photograph. The medium 2 is not limited to a sheet-like medium such as A-four paper or A-three paper, and includes a card, a booklet, and the like. The medium 2 is also referred to as a document.

The image reading apparatus 1 includes a medium conveyance apparatus 3 that conveys a medium 2 in a conveyance direction F, a reading unit 4 that reads the image on the medium 2 conveyed in the conveyance direction F by the medium conveyance apparatus 3, and a controller 5 that controls operations of the medium conveyance apparatus 3 and the reading unit 4.

### Medium Conveyance Apparatus

As illustrated in FIG. 1, the medium conveyance apparatus 3 includes a medium placement section 6, a feed roller 7, a separation roller 8, a conveyance roller 9, and another conveyance roller 10.

The medium placement section 6 has a placement surface 11 on which a bundle 21 of media 2 as a conveyance target can be placed. The placement surface 11 is inclined rearward (toward the -Y direction) as illustrated. Further, the medium placement section 6 includes a pair of edge guides 12, 12 at both sides in the width direction (the X-axis direction) of the placement surface 11. The pair of edge guides 12, 12 come into contact with both sides of the medium 2 placed on the placement surface 11 to guide the conveyance.

The medium placement section 6 creates a state where the medium 2 to be set is aligned at the center position in the width direction (the X-axis direction) of the placement surface 11 by the pair of edge guides 12, 12. The medium 2 is sent, that is, fed by the feed roller 7 described later in a state of being aligned in this manner. The medium placement section 6 is configured as a center feeding system.

When the medium 2 is set on the placement surface 11 of the medium placement section 6, there is created a state in which the leading end of the medium 2 comes into contact with the feed roller 7.

The feed roller 7 applies feeding force S in the conveyance direction F to the medium 2 by rotating in contact with the medium 2 placed on the medium placement section 6. The feed roller 7 is driven by rotational power transmitted from a motor (not illustrated).

The separation roller 8 rotates in an opposite direction to the rotation of the feed roller 7, and when defining a medium that receives the feeding force S out of the bundle 21 of the plurality of media as a first medium 2, the separation roller 8 applies separation force D to the media 2 except that first medium 2. The separation roller 8 is also driven by rotational power transmitted from a motor (not illustrated).

The separation roller 8 is configured to be able to come into contact with and separate from the feed roller 7, and is further applied with pressing force P toward the feed roller 7 by a spring (not illustrated). When the plurality of media 2 is about to enter between the separation roller 8 and the feed roller 7, the separation roller 8 rotates in the opposite direction while retreating against the pressing force P.

The separation roller 8 is provided with a torque limiter (not illustrated), and when there is no medium between the separation roller 8 and the feed roller 7 or there is only one medium, slippage occurs in the torque limiter, and the separation roller 8 is rotated in accordance with the rotation of the feed roller 7.

When there are two or more media between the separation roller 8 and the feed roller 7, slippage occurs between the media, and the separation roller 8 rotates in the opposite direction to that of the feed roller 7 and applies the separation force D to the medium 2 that comes into contact with the separation roller 8, and returns the medium 2 to the upstream where the placement surface 11 is located. As a result, double-feeding is prevented.

The conveyance roller 9 conveys the medium 2 fed from the feed roller 7 in the conveyance direction F along a conveyance path 13. The conveyance roller 9 is a roller pair that rotates while nipping the medium 2, and applies conveyance force to the medium 2. The conveyance roller 9 is located upstream of the reading unit 4. The conveyance roller 9 conveys the medium 2 so as to pass through a reading area of the reading unit 4.

The other conveyance roller 10 is located downstream of the reading unit 4. The other conveyance roller 10 is also a roller pair that rotates while nipping the medium 2. The other conveyance roller 10 discharges, onto the discharge tray 14, the medium 2 on which reading by the reading unit 4 has been performed.

The conveyance roller 9 and the other conveyance roller 10 are driven by rotational power transmitted from a motor (not illustrated).

### Reading Unit

As described above, the reading unit 4 is located between the conveyance roller 9 and the other conveyance roller 10. Here, the reading unit 4 includes a contact image sensor module of a CIS type or a CCD type.

The reading unit 4 includes a first reading unit 41 that reads an image on a front surface of the medium 2 and a second reading unit 42 that reads an image on a reverse surface of the medium 2. That is, the reading unit 4 reads both the front surface 2a and the back surface 2b of the medium 2. Note that the reading unit 4 may be configured so as to be capable of reading only one surface.

The controller 5 controls an overall operation of the image reading apparatus 1 including operations of the medium conveyance apparatus 3 and the reading unit 4.

Here, the controller 5 includes a CPU, a flash ROM, and a RAM. The CPU performs various types of arithmetic processing in accordance with various programs stored in the flash ROM to control the overall operation of the image reading apparatus 1. The flash ROM, which is an example of a storage device, is a readable and writable nonvolatile memory. The RAM, which is an example of the storage device, is used as a work area of the CPU and temporarily stores various types of information.

### Embodiment 1

The medium conveyance apparatus 3 according to Embodiment 1 will be described with reference to FIGS. 1 to 9. The medium conveyance apparatus 3 of Embodiment 1 includes the medium placement section 6 described above, the feed roller 7 described above, the separation roller 8 described above, and the controller 5 that controls operations of the feed roller 7 and the separation roller 8 described above.

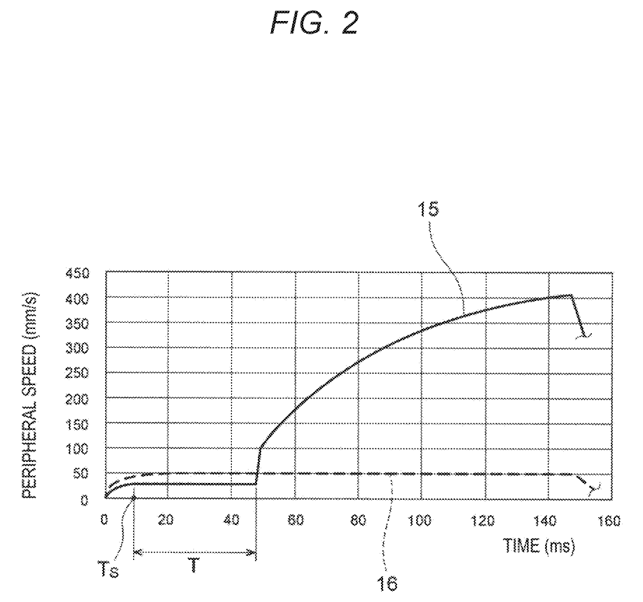

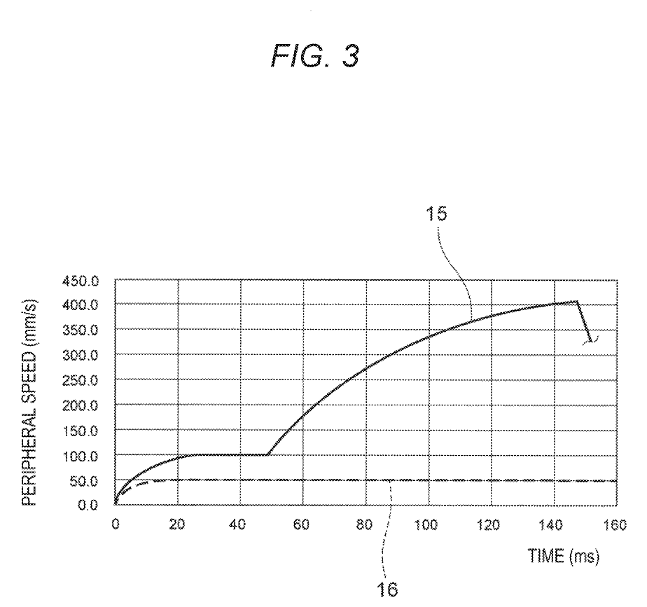

FIG. 2 illustrates a change in the peripheral speed 15 of the feed roller 7 and the peripheral speed 16 of the separation roller 8 when a first medium 2 is separated and fed when defining a medium that receives the feeding force S from the feed roller 7 out of the bundle 21 of the plurality of media in a state of being set on the medium placement section 6 as the first medium. In FIG. 3 described later and FIG. 2, the vertical axis represents the peripheral speed in millimeters/second (mm/s). The horizontal axis represents time in milliseconds (ms).

As illustrated in FIG. 2, in the present embodiment, the controller 5 performs control so that the peripheral speed 16 of the separation roller 8 is equal to or higher than the peripheral speed 15 of the feed roller 7 during a predetermined period T after the feed roller 7 applies the feeding force S to the first medium 2 which receives the feeding force S from the feed roller 7 out of the bundle 21 of the plurality of media set on the medium placement section 6.

Here, a start time point Ts of the predetermined period T is not the same as a time point when the feed roller 7 applies the feeding force S to the medium 2, that is, a time point of the origin, and a time point when the acceleration region of the feed roller 7 has elapsed immediately after the feeding force S is applied to the medium 2 is used. Note that the start time point Ts of the predetermined period T may be a time point when the feed roller 7 applies the feeding force S to the medium 2, that is, the time point of the origin.

The time length of the predetermined period T is determined so that the double-feeding of the media 2 can be reduced by controlling the peripheral speed 16 of the separation roller 8 to be equal to or higher than the peripheral speed 15 of the feed roller 7.

In addition, it is sufficient for the peripheral speed 16 of the separation roller 8 to be equal to or higher than the peripheral speed 15 of the feed roller 7 in the predetermined period T. However, in order to improve the separation function, it is more preferable for the peripheral speed 16 of the separation roller 8 to be set higher than the peripheral speed 15 of the feed roller 7 than to be set the same as the peripheral speed 15 of the feed roller 7.

In the present embodiment, the predetermined period T is set so as to end when the leading end of the first medium 2 thus separated is nipped by the conveyance roller 9. Subsequently, the first medium 2 thus separated is in the state of being conveyed with conveyance force of the conveyance roller 9.

Information on the timing at which the leading end of the medium 2 is nipped by the conveyance roller 9 is acquired by a medium sensor (not illustrated). The medium sensor is disposed at a front position in the conveyance direction F of the conveyance roller 9 in the conveyance path 13. The medium sensor is a sensor capable of sensing passage of the leading end of the medium 2, and information thus sensed is sent to the controller 5.

The acquisition of the information on the timing at which the leading end of the medium 2 is nipped by the conveyance roller 9 is not limited to the acquisition by the medium sensor. The information may be acquired by performing arithmetic processing from a moving image of the leading end position of the medium 2 captured by, for example, a camera. Alternatively, the nipping timing may be acquired by repeating actual measurement in advance.

Further, as illustrated in FIG. 2, in the present embodiment, the controller 5 performs control such that the peripheral speed 15 of the feed roller 7 becomes higher than the peripheral speed 16 of the separation roller 8 after the predetermined period T elapses. Specifically, there is adopted a configuration in which the peripheral speed 15 of the feed roller 7 is accelerated to match a state in which the medium 2 is conveyed with the conveyance force of the conveyance roller 9.

The controller 5 is configured to decelerate and stop the feed roller 7 shortly before the trailing end of the first medium 2 leaves the feed roller 7. Further, the controller 5 is configured to decelerate and stop the separation roller 8 shortly before the trailing end of the first medium 2 leaves the feed roller 7.

In addition, as illustrated in FIG. 3, in the present embodiment, when separating a second medium 2 following the first medium 2, the controller 5 performs control such that the peripheral speed 15 of the feed roller 7 becomes higher than the peripheral speed 16 of the separation roller 8.

That is, when separating the second medium 2, both the feed roller 7 and the separation roller 8 are brought into a constant-speed state from a stopped state via an accelerated state. In all of the accelerated state and the constant-speed state, the peripheral speed 15 of the feed roller 7 is controlled to be higher than the peripheral speed 16 of the separation roller 8.

The controller 5 is configured to change the state of the feed roller 7 from the constant-speed state to the accelerated state to match the state in which the medium 2 is conveyed with the conveyance force of the conveyance roller 9 when the leading end of the second medium 2 is nipped by the conveyance roller 9.

Further, as illustrated in FIG. 3, the controller 5 is configured to decelerate and stop the feed roller 7 shortly before the trailing end of the second medium 2 leaves the feed roller 7.

On the other hand, the controller 5 is configured to continue the constant-speed state of the separation roller 8 but not to stop the separation roller 8 until the separation of a third medium 2 is started. That is, when separating the second and subsequent media 2, the separation of the third and subsequent media 2 and the separation of the fourth and subsequent media 2 proceed in order, but the separation roller 8 is configured not to stop but to keep the constant-speed rotation when performing the separation.

Further, as illustrated in FIGS. 2 and 3, in the present embodiment, the controller 5 controls the peripheral speed 16 of the separation roller 8 so as to be substantially the same between when separating the first medium 2 (FIG. 2) and when separating the second medium 2 (FIG. 3).

That is, both when separating the first medium 2 (FIG. 2) and when separating the second medium 2 (FIG. 3), the peripheral speed 16 of the separation roller 8 is brought into the constant-speed state from the origin position via the accelerated state, but the speeds are the same.

When separating the first medium 2 (FIG. 2), the separation roller 8 is decelerated and stopped before the trailing end of the first medium 2 leaves the feed roller 7, but when separating the second medium 2 (FIG. 3), the separation roller 8 is not stopped, which is the only difference from when separating the first medium 2.

### Description of Separation of Medium in Embodiment 1

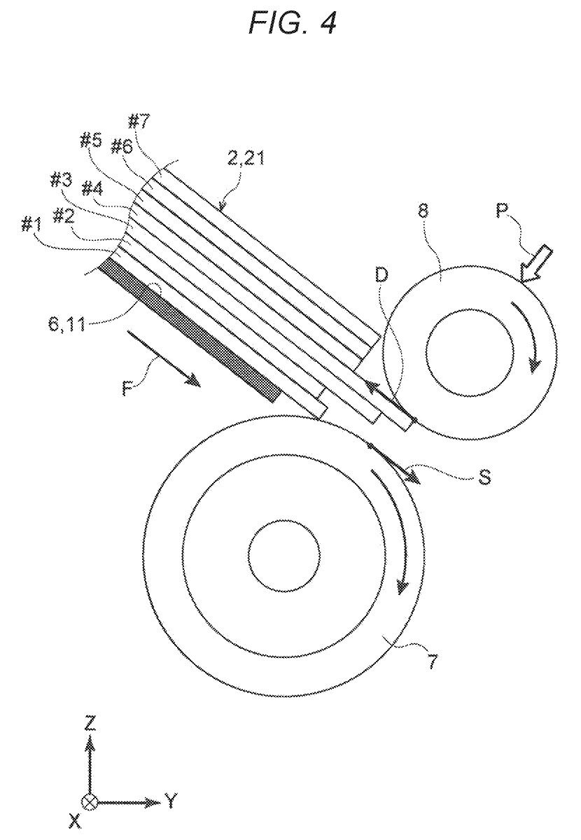

The separation of the medium 2 during the predetermined period T in Embodiment 1 will be described with reference to FIGS. 4 to 9. As illustrated in FIG. 2, during the predetermined period T, the peripheral speed 16 of the separation roller 8 is set higher than the peripheral speed 15 of the feed roller 7.

(1) FIG. 4 corresponds to a state in which a plurality of media 2 is set on the placement surface 11 of the medium placement section 6 in a state in which the leading ends thereof are not aligned, and the feed roller 7 and the separation roller 8 rotate to start the separation processing. The medium 2 (#1) receives the feeding force S from the feed roller 7 and starts to proceed in the conveyance direction F.

The medium 2 (#4), which is unaligned and has the most protruding leading end, comes into contact with the separation roller 8. The medium 2 (#4) starts to be retreated with retreating force D by the high peripheral speed 16 described above.

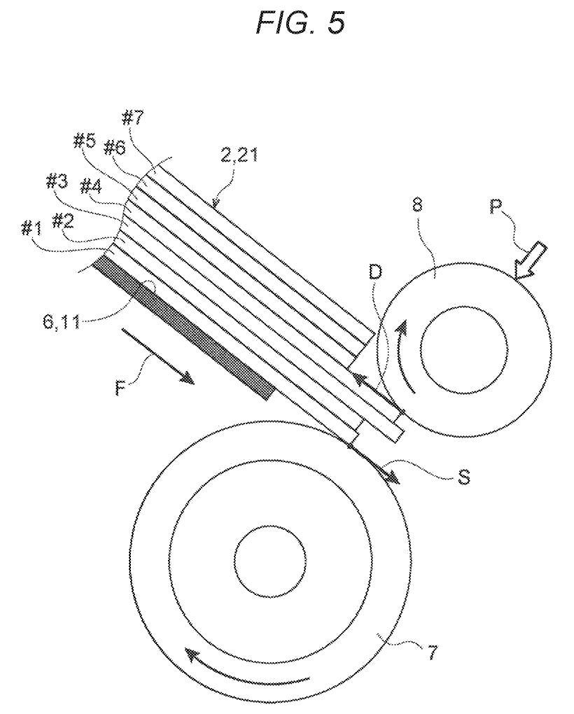

(2) FIG. 5 following FIG. 4 illustrates a state in which the medium 2 (#4) is in the middle of being retreated, but the medium 2 (#3) proceeds in the conveyance direction F because the medium 2 (#3) is not in contact with the separation roller 8. The medium 2 (#1) further proceeds in the conveyance direction F with the feeding force S of the feed roller.

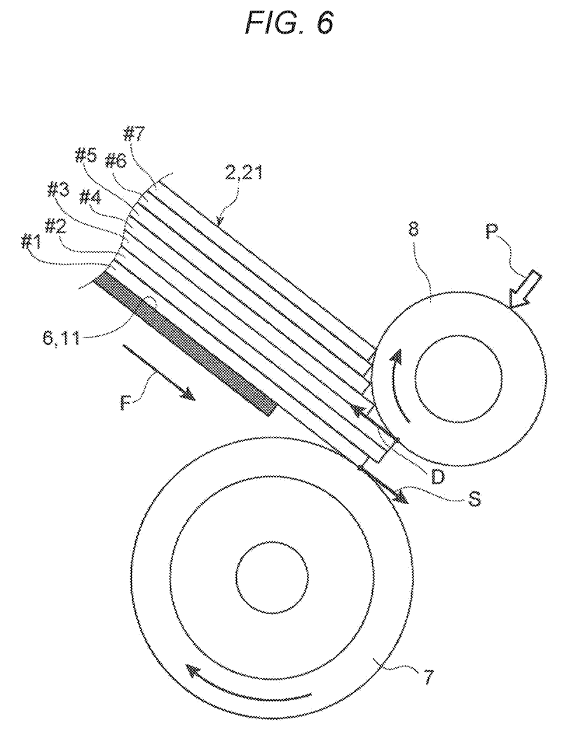

(3) FIG. 6 following FIG. 5 illustrates a state in which the state where the medium 2 (#4) is retreated ends, and the medium 2 (#3) is in contact with the separation roller 8 to receive the retreating force D in turn. The medium 2 (#1) further proceeds in the conveyance direction F with the feeding force S of the feed roller.

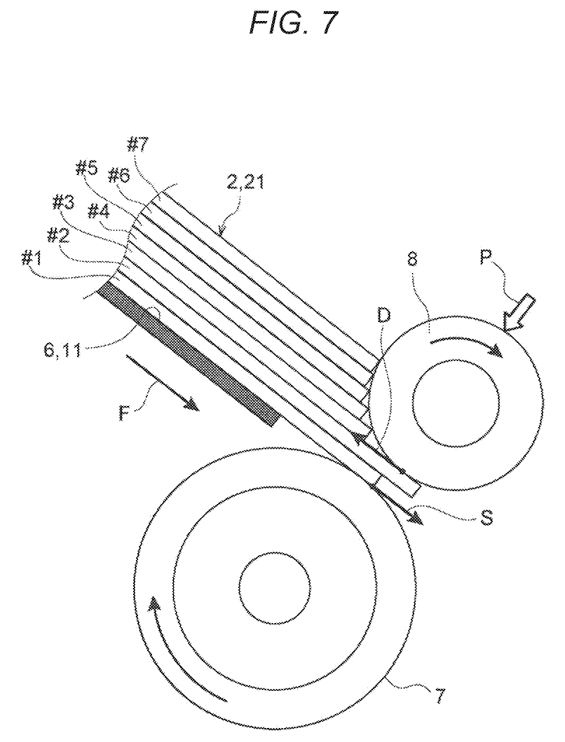

(4) FIG. 7 following FIG. 6 illustrates a state in which the state where the medium 2 (#3) is retreated ends, and the medium 2 (#2) is in contact with the separation roller 8 to receive the retreating force D in turn. The medium 2 (#1) further proceeds in the conveyance direction F with the feeding force S of the feed roller.

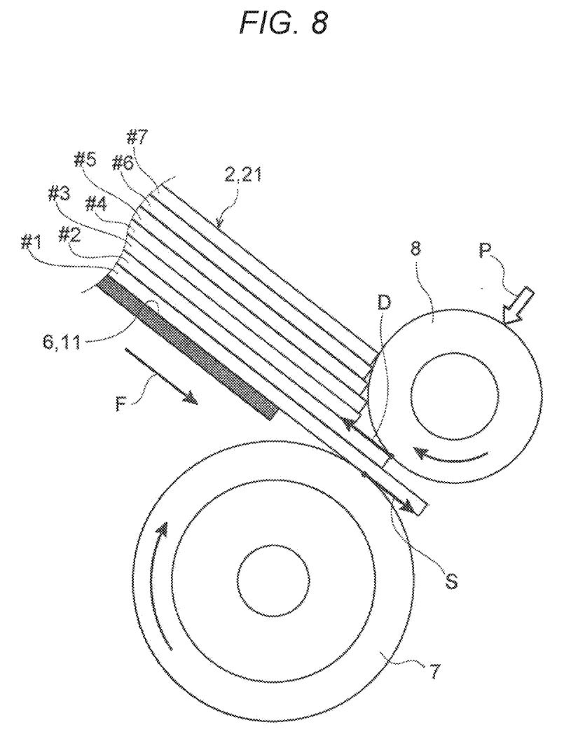

(5) FIG. 8 following FIG. 7 illustrates a state in which the state where the medium 2 (#2) is retreated is further advanced. The medium 2 (#1) further proceeds in the conveyance direction F with the feeding force S of the feed roller.

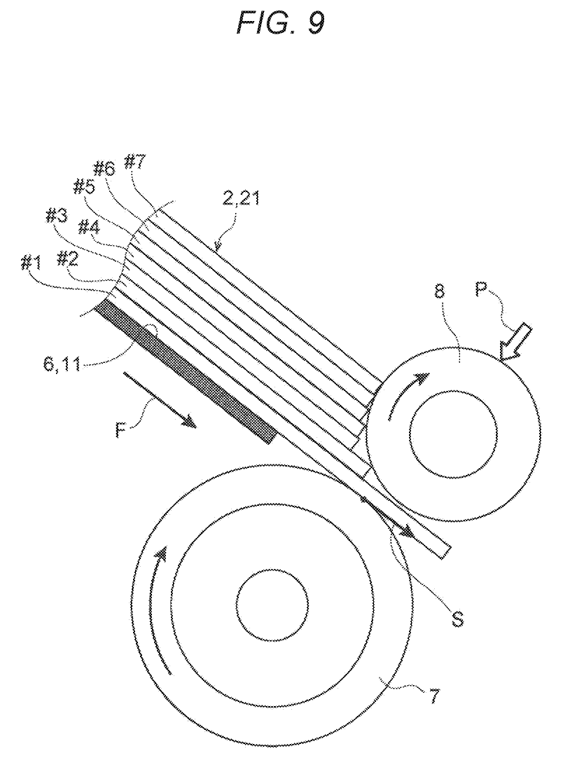

(6) FIG. 9 following FIG. 8 illustrates a state at a time point when the state where the medium 2 (#2) is retreated ends. The medium 2 (#1) is brought into the state of being separated into a single medium 2 by the separation processing with the separation roller 8, and is fed in the conveyance direction F with the feeding force S of the feed roller.

### Description of Advantages of Embodiment 1

(1) In the present embodiment, the controller 5 is configured to perform the control so that the peripheral speed 16 of the separation roller 8 is equal to or higher than the peripheral speed 15 of the feed roller 7 during the predetermined period T after applying the feeding force S by the feed roller 7 to the first medium 2 (#1) (FIG. 2).

As a result, since a retreating speed in the opposite direction (opposite direction to the direction of the feeding force S) of the media 2 (#2, #3, ...) other than the first medium by the separation roller 8 becomes faster than ever before, the separation function with the separation roller 8 is enhanced. That is, for example, even when the plurality of media 2 are set on the medium placement section 6 in an unaligned state in which the leading ends thereof are not aligned, the separation function is less likely to be affected by the unaligned state of the plurality of media 2. As a result, the first medium 2 (#1) can be easily separated, and thus it is possible to reduce the possibility of causing double-feeding.

In addition, by the rotation of the separation roller 8 in the opposite direction in the predetermined period T, the state is changed toward the state in which the leading ends of the media 2 set in the unaligned state are aligned. Accordingly, it is possible to remedy the unaligned state of the downstream leading ends of the plurality of media 2. Therefore, in the separation processing of the second and subsequent media 2, 2 (#2, #3, ...) following the first medium 2 (#1), the processing can be performed in a state where the leading ends of the media 2 are aligned.

(2) In addition, in the present embodiment, the controller 5 is configured to perform the control such that the peripheral speed 15 of the feed roller 7 becomes higher than the peripheral speed 16 of the separation roller 8 after the predetermined period T elapses (FIG. 2). Thus, it is possible to improve throughput in the conveyance of the medium 2 accordingly by an increase in the peripheral speed 15 of the feed roller 7.

(3) In addition, in the present embodiment, the predetermined period T ends when the leading end of the first medium 2 (#1) thus separated is nipped by the conveyance roller 9, that is, when the leading end is nipped and provided with the conveyance force. Accordingly, it is possible to more effectively suppress the possibility of double-feeding due to the bundle 21 of unaligned media. Further, at the same time, it is possible to further remedy the unaligned state of the downstream leading ends of the plurality of media 2 set on the medium placement section 6 in the unaligned state.

(4) Further, in the present embodiment, the controller 5 is configured to perform the control such that the peripheral speed 15 of the feed roller 7 is higher than the peripheral speed 16 of the separation roller 8 when separating the second medium 2 (#2) following the first medium 2 (#1) (FIG. 3).

As described above, in the separation processing of the first medium 2 (#1), the unaligned state of the downstream leading ends of the bundle 21 of the plurality of media is remedied. Therefore, in the separation processing of the second medium 2 (#2), the processing of remedying the unaligned state as in the first medium 2 (#1) is unnecessary. Accordingly, it is possible to control the peripheral speed 15 of the feed roller 7 to be higher than the peripheral speed 16 of the separation roller 8. Therefore, when separating the second medium 2 (#2), it is possible to improve the throughput in the conveyance of the second and subsequent media 2, 2, ... (#2, #3, ...) accordingly by the fact that the peripheral speed 15 of the feed roller 7 is set high from the beginning.

(5) Further, in the present embodiment, the controller 5 is configured to control the peripheral speed 16 of the separation roller 8 so as to be substantially the same between when separating the first medium 2 (#1) and when separating the second medium 2 (#2). That is, the peripheral speed 15 of the feed roller 7 changes, but the peripheral speed 16 of the separation roller 8 does not change between when separating the first medium 2 (#1) and when separating the second medium 2 (#2). Therefore, it is possible to suppress complication of the control by the controller 5.

### Embodiment 2

Then, a medium conveyance apparatus 3 according to Embodiment 2 will be described with reference to FIGS. 4 to 9. The same portions as those of Embodiment 1 are denoted by the same reference symbols to omit the descriptions of the configurations and the corresponding operations and advantages thereof.

In Embodiment 2, the controller 5 is configured to execute the following control on the (N+2)-th medium 2 following the separation processing of a predetermined number N of the media from the separation of the first medium 2. Here, the predetermined number N is a positive integer no smaller than 3 and is set in advance.

That is, the controller 5 is configured to perform the control so that the peripheral speed 16 of the separation roller 8 is equal to or higher than the peripheral speed 15 of the feed roller 7 during the predetermined period T after applying the feeding force S by the feed roller 7 to the (N+2)-th medium 2.

As illustrated in FIG. 2 and FIGS. 4 to 9, in the bundle 21 (the state in FIG. 4) of the media in the unaligned state set on the medium placement section 6, as illustrated in FIG. 9, the medium 2 (#1), which is the first medium 2, is separated and is fed as a single medium in the conveyance direction F. On this occasion, the plurality of media 2 from #2 to #7 are provided with the retreating force D during the predetermined period T by the separation processing (the processing from FIG. 4 to FIG. 9) with the separation roller 8, and thus the unaligned state of the leading ends is remedied to be brought into the aligned state.

However, when the number of media in the bundle 21 set on the medium placement section 6 is large, the range in which the leading ends of the media 2 are unaligned also increases. Therefore, the unaligned state is remedied by the separation processing of the medium 2 (#1) only in the media that are located at the position where the media are brought into contact with the separation roller 8 during the predetermined period T and are provided with the retreating force D. That is, since the plurality of media 2 located away from the separation roller 8 is not provided with the retreating force D during the predetermined period T, the unaligned state is apt to be maintained.

In the present embodiment, as described above, the controller 5 performs the control so that the peripheral speed 16 of the separation roller 8 is equal to or higher than the peripheral speed 15 of the feed roller 7 during the predetermined period T after applying the feeding force S by the feed roller 7 to the (N+2)-th medium 2. As a result, even when the plurality of media 2 is located away from the separation roller 8, the unaligned state is remedied.

Here, the predetermined number N is set to, for example, 10. This is set as a range in which the unaligned state is remedied by the separation processing of the medium 2 (#1). Obviously, the predetermined number N is not limited to 10. The predetermined number N is set based on the size and the peripheral speed 16 of the separation roller 8.

Note that it is desirable to adopt a configuration in which the predetermined number N can be changed by the user.

In the present embodiment, the controller 5 performs the control so that the peripheral speed 16 of the separation roller 8 is equal to or higher than the peripheral speed 15 of the feed roller 7 similarly to the separation processing of the first medium 2 (#1) during the predetermined period T after applying the feeding force S by the feed roller 7 to the (N+2)-th medium 2 following the execution of the separation processing of the predetermined number N of media. Accordingly, substantially the same advantages as those when separating the first medium 2 (#1) can be obtained for the (N+2)-th and subsequent media in the bundle 21.

### Embodiment 3

Then, a medium conveyance apparatus 3 according to Embodiment 3 will be described with reference to FIG. 1. The same portions as those of Embodiment 1 or Embodiment 2 are denoted by the same reference symbols to omit the descriptions of the configurations and the corresponding operations and advantages thereof.

In the medium conveyance apparatus 3 of Embodiment 3, the controller 5 can receive a change command for changing the length of the predetermined period T. Further, the controller 5 is configured to change the length of the predetermined period T upon reception of the change command.

As illustrated in FIG. 1, in the present embodiment, the image reading apparatus 1 includes an operation panel 18 on the front side (+Y side). The operation panel 18 displays various reading configurations, reading execution operations, and reading contents with the reading unit 4. The operation panel 18 is further provided with a function of receiving the change command to change the length of the predetermined period T.

The degree of appropriateness of the length of the predetermined period T may change in some cases due to a difference in type of the medium 2 to be separated, a change in environment such as temperature and humidity, and so on.

In the present embodiment, the controller 5 is configured to change the predetermined period T to a new length of the predetermined period T based on the change command for changing the length of the predetermined period T upon reception of the change command. Accordingly, the length of the predetermined period T can be changed in accordance with the difference in type of the medium 2, the change in environment such as temperature and humidity, and so on. Accordingly, it is possible to realize effective separation of the bundle 21 of the unaligned media.

### Other Embodiments

The medium conveyance apparatus 3 and the image reading apparatus 1 according to the present disclosure basically include the configurations of the embodiments described above, but as a matter of course, changes, omissions, and so on of partial configuration can be made without departing from the scope of the present disclosure.

In Embodiments 1 to 3, the medium conveyance apparatus 3 is provided to the image reading apparatus 1, but this is not a limitation. For example, the medium conveyance apparatus 3 may be a medium conveyance apparatus provided to a recording apparatus such as an inkjet printer.

What is claimed is:

1. A medium conveyance apparatus comprising:
a medium placement section on which a bundle of media is placed;
a feed roller configured to apply feeding force in a conveyance direction to the media placed on the medium placement section by rotating in contact with the media;
a separation roller configured to rotate in an opposite direction to a direction of the rotation of the feed roller to apply separation force to the media except a first medium which receives the feeding force out of the bundle of the media; and
a controller configured to control operations of the feed roller and the separation roller, wherein
the controller performs control such that a peripheral speed of the separation roller is equal to or higher than a peripheral speed of the feed roller during a predetermined period after the feed roller applies the feeding force to the first medium.

2. The medium conveyance apparatus according to claim 1, wherein
the controller is configured to
receive a change command to change a length of the predetermined period, and
change the length of the predetermined period upon reception of the change command.

3. The medium conveyance apparatus according to claim 1, wherein
the controller performs control such that the peripheral speed of the feed roller is higher than the peripheral speed of the separation roller after the predetermined period elapses.

4. The medium conveyance apparatus according to claim 1, further comprising
a conveyance roller configured to convey the medium downstream in the conveyance direction of the feed roller, wherein
the predetermined period ends when a leading end of the first medium separated is nipped by the conveyance roller.

5. The medium conveyance apparatus according to claim 1, wherein
the controller performs control such that the peripheral speed of the feed roller is higher than the peripheral speed of the separation roller when separating a second medium following the first medium.

6. The medium conveyance apparatus according to claim 1, wherein
the controller controls the peripheral speed of the separation roller so as to be substantially the same between when separating the first medium and when separating the second medium.

7. The medium conveyance apparatus according to claim 1, wherein
the controller performs control such that the peripheral speed of the separation roller is equal to or greater than the peripheral speed of the feed roller during a predetermined period after the feeding force is applied by the feed roller to an (N+2)-th medium following separation of a predetermined number N (N is a positive integer no smaller than 3) of media from the separation of the first medium.

8. An image reading apparatus comprising:
the medium conveyance apparatus according to claim 1; and
a reading unit configured to read an image on the medium conveyed in the conveyance direction by the medium conveyance apparatus.
